(19) United States
(12) Patent Application Publication
(10) Pub. No.: US 2026/0156296 A1
(43) Pub. Date: Jun. 4, 2026

(54) METHOD AND APPARATUS FOR VIDEO CODING BY USING PREDICTION-TRANSFORM SKIPPING

(71) Applicants: HYUNDAI MOTOR COMPANY, Seoul (KR); KIA CORPORATION, Seoul (KR); DIGITALINSIGHTS INC., Seoul (KR)

(72) Inventors: Yong Jo Ahn, Seoul (KR); Jong Seok Lee, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); DIGITALINSIGHTS INC., Seoul (KR)

(21) Appl. No.: 18/865,286

(22) PCT Filed: May 8, 2023
(86) PCT No.: PCT/KR2023/006197

§ 371 Date: Nov. 12, 2024

(30) Foreign Application Priority Data
May 16, 2022 (KR) 10-2022-0059428
May 2, 2023 (KR) 10-2023-0057062

(51) Int. Cl. H04N 19/61; H04N 19/124; H04N 19/132; H04N 19/176; H04N 19/503; H04N 19/593; H04N 19/70; H04N 19/82; H04N 19/86

(52) U.S. Cl. CPC H04N 19/61; H04N 19/124; H04N 19/132; H04N 19/176; H04N 19/70; H04N 19/503; H04N 19/593; H04N 19/82; H04N 19/86

(57) ABSTRACT

A method and an apparatus are disclosed for video coding utilizing prediction-transform skipping. In the disclosed embodiments, a video decoding device decodes a prediction skipping flag and a quantized transform block of the current block. The video decoding device inversely quantizes the quantized transform block to generate an inversely quantized transform block of the current block. When the prediction skipping flag is true, the video decoding device inversely transforms the inversely quantized transform block to generate a reconstructed block and stores the reconstructed block to filter the current picture and predict a next block.

### TECHNICAL FIELD

The present disclosure relates to a method and an apparatus device utilizing prediction-transform skipping.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In general, video represents digital image data acquired using a video acquisition device. Recently, methods of mapping various data, such as geometry information of point clouds, attribute information, occupation information, feature maps of neural networks, and parameters of neural networks, as well as general video, to a two-dimensional (2D) space and then compressing the mapped data using image or video coding have been actively researched. In particular, in video-based point cloud compression (V-PCC), an international compression standard technology for point clouds, the geometry information, attribute information, and occupation information of point clouds are each imaged, and then compressed using the video codec H.265/HEVC.

Unlike general videos, a video mapped onto a 2D space may be in the form of sparse video in which most pixel values are 0 and only a few pixel values have non-zero values, as shown in the example of FIG. 6. When block-by-block prediction and transform for the sparse video is performed as illustrated in FIG. 6, high-frequency signals may be newly generated, which may degrade compression efficiency. Nevertheless, in the existing video compression method, a prediction step or a prediction-transform step cannot be skipped. Therefore, in order to improve the video encoding efficiency and image quality, a method for efficiently processing the prediction-transform step needs to be considered.

### DISCLOSURE

### Technical Problem

The present disclosure seeks to provide a video coding method and an apparatus utilizing prediction-transform skipping in video encoding and decoding related to various types of video formats including a sparse video.

### Technical Solution

At least one aspect of the present disclosure provides a method of decoding a current block, performed by a video decoding device. The method includes decoding a prediction skipping flag and a quantized transform block of the current block from a bitstream. Here, the prediction skipping flag indicates skipping of prediction for the current block. The method also includes inversely quantizing the quantized transform block to generate an inversely quantized transform block of the current block. The method also includes checking the prediction skipping flag. When the prediction skipping flag is true, the method further includes inversely transforming the inversely quantized transform block to generate a reconstructed block and storing the reconstructed block to filter the current picture and predict a next block.

Another aspect of the present disclosure provides a method of decoding a current block, performed by a video encoding device. The method includes acquiring the current block and transforming the current block to generate a first transform block. The method also includes generating a prediction block of the current block. The method also includes subtracting the prediction block from the current block to generate a residual block and transforming the residual block to generate a second transform block.

Yet another aspect of the present disclosure provides a computer-readable recording medium storing a bitstream generated by a video encoding method. The video encoding method includes acquiring a current block and transforming the current block to generate a first transform block. The video encoding method also includes generating a prediction block of the current block. The video encoding method also includes subtracting the prediction block from the current block to generate a residual block and transforming the residual block to generate a second transform block.

### Advantageous Effects

As described above, the present disclosure provides a video coding method and an apparatus utilizing prediction-transform skipping in video encoding and decoding. Thus, regarding various types of video formats including a sparse video, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating one block in a sparse video.

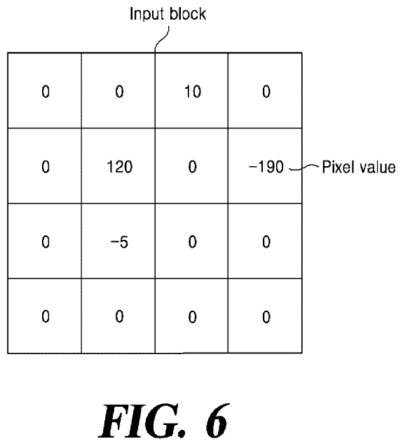

FIG. 7 is a block diagram illustrating a video encoding device using prediction skipping according to an embodiment of the present disclosure.

FIG. 8 is a block diagram illustrating a video decoding device using prediction skipping according to an embodiment of the present disclosure.

FIG. 9 is a block diagram illustrating a video encoding device using prediction-transform skipping according to an embodiment of the present disclosure.

FIG. 10 is a block diagram illustrating a video decoding device using prediction-transform skipping according to an embodiment of the present disclosure.

FIG. 11 is a flowchart illustrating a method for encoding a current block performed by a video encoding device according to an embodiment of the present disclosure.

FIG. 12 is a flowchart illustrating a method for decoding a current block performed by a video decoding device according to an embodiment of the present disclosure.

FIG. 13 is a flowchart illustrating a method for encoding a current block performed by a video encoding device according to another embodiment of the present disclosure.

FIG. 14 is a flowchart illustrating a method for decoding a current block performed by a video decoding device according to another embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

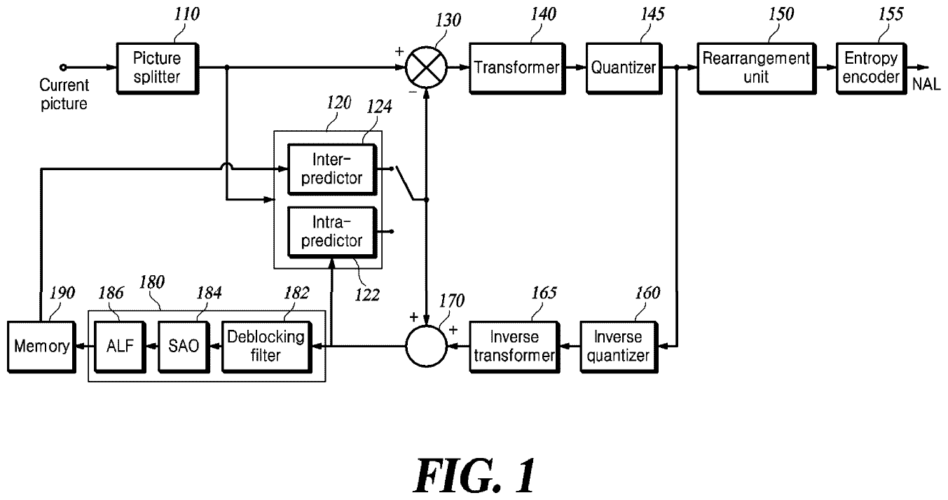

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

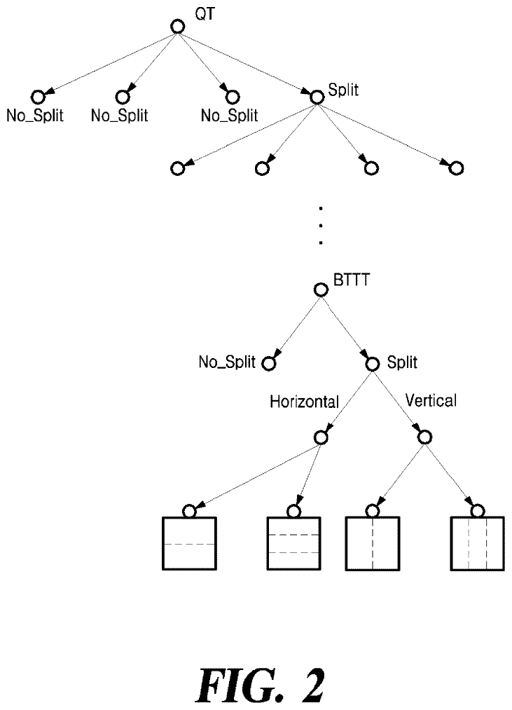

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

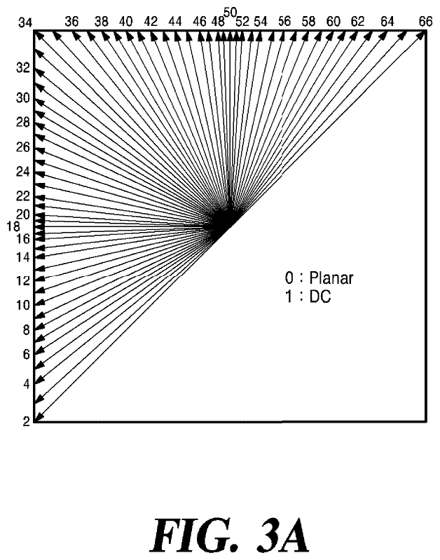

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring, blocks of the current block.

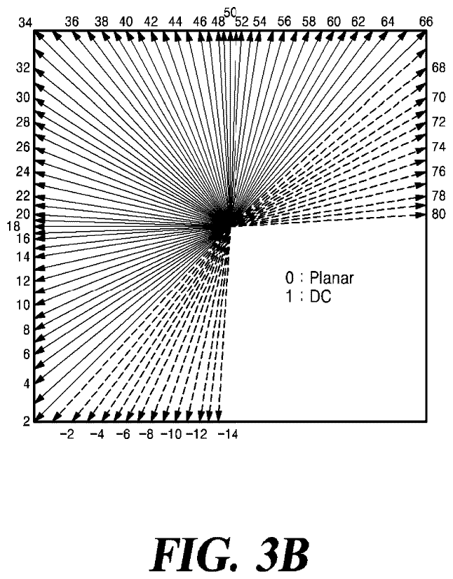

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus, Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a ID coefficient sequence by using coefficient scanning. For example, the rearrangement unit 150 may output the ID coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of ID quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

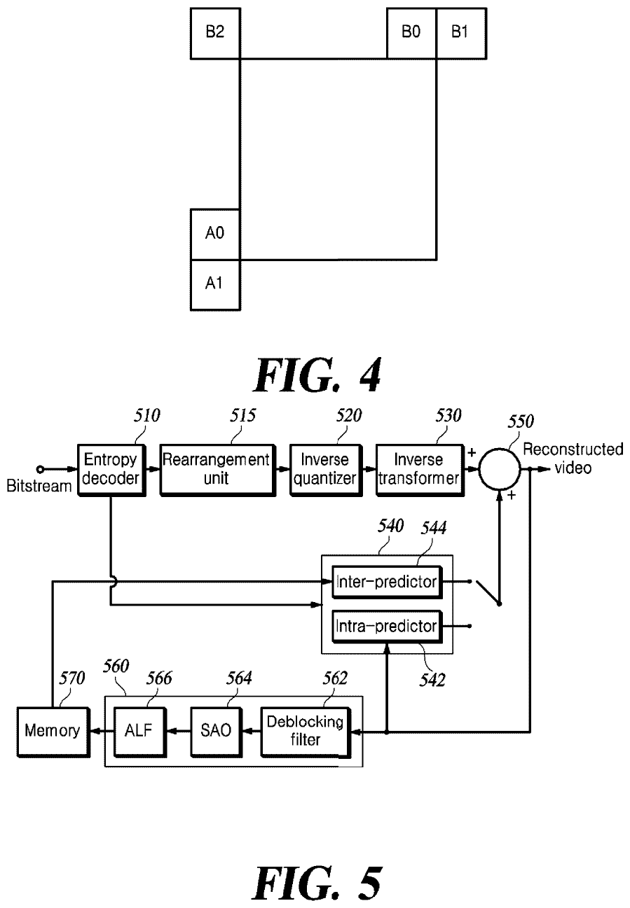

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of ID quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus using prediction-transform skipping in video encoding and decoding related to various types of video formats including a sparse video.

The following embodiments may be performed by the components in the video encoding device. The following embodiments may also be performed by the components in the video decoding device.

The video encoding device in the encoding of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

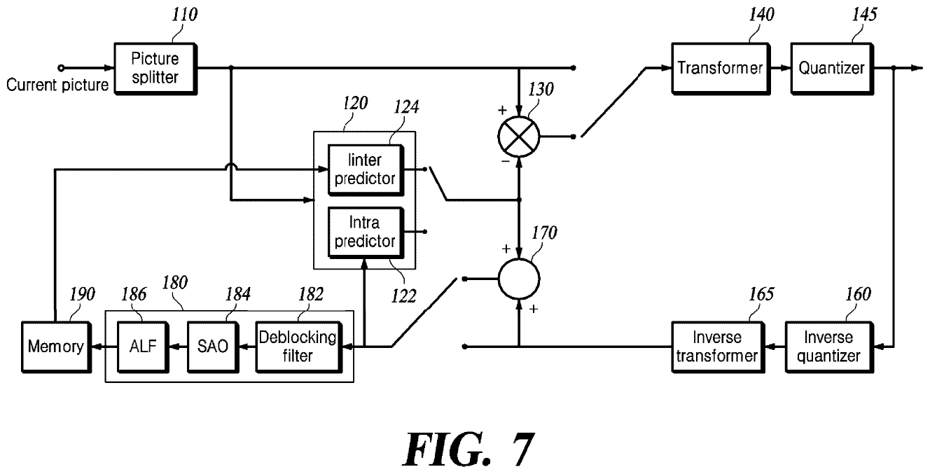

FIG. 7 is a block diagram illustrating a video encoding device using prediction skipping according to an embodiment of the present disclosure.

The video encoding device illustrated in FIG. 7 further includes a portion that performs prediction skipping in addition to the components illustrated in FIG. 1. Hereinafter, operations different from the example of FIG. 1 are described. In addition, operations of components not included in FIG. 7 are described based on FIG. 1.

The picture splitter 110 receives a current picture and splits the picture into a plurality of layers, such as slices/tiles, coding tree units, coding units, and the like. Here, the coding unit indicates the current block, which is a unit for coding. Thereafter, based on prediction skipping information, the current block may be directly transferred to the transformer 140, or a residual block generated by subtracting a prediction block transferred from the predictor 120 from the current block may be transferred to the transformer 140. Hereinafter, the prediction skipping information may be a prediction skipping flag, which is a 1-bit flag.

For example, if the prediction skipping flag is 1, the video encoding device may directly transfer the input block to the transformer 140 without performing prediction. Meanwhile, if the prediction skipping flag is 0, the subtractor 130 may subtract the prediction block transferred from the predictor 120 from the current block to generate a residual block, and the residual block may be transferred to the transformer 140.

The prediction skipping flag may be high level information and may be signaled at one or more levels among a video level, a picture level, and a slice level. In other words, the prediction skipping flag may be encoded by the entropy encoder 155 and then may be transmitted to the video decoding device. In addition, depending on the prediction skipping information of a high level than each level, the video encoding device may determine whether to encode the prediction skipping flag at the corresponding level. For example, the prediction skipping information of a high level than the current level may be checked, and if a value of the prediction skipping flag of the high level is 0, the video encoding device may set the prediction skipping flag of the current level to 0 and may not signal the prediction skipping flag to the video decoding device.

The transformer 140 may transform the received block to generate a transform block. The generated transform block may be transmitted to the quantizer 145.

The quantizer 145 may quantize the input transform block to generate a quantized transform block. The quantizer 145 may check the prediction skipping information and perform quantization based on the prediction skipping information. For example, the quantizer 145 may use different quantization parameters depending on whether the prediction is skipped. The generated quantized transform block may be transmitted to the rearrangement unit 150 and the inverse quantizer 160.

In the VVC technology, a quantization parameter of the current block is calculated based on a prediction quantization parameter and a residual quantization parameter. The prediction quantization parameter is derived from the quantization parameters of the neighboring blocks. The residual quantization parameter corresponds to a difference between the quantization parameters of the current block and a previous block. In the present implementation example, a quantization parameter offset may be additionally utilized to use different quantization parameters depending on whether prediction is skipped. In the present implementation example, the quantization parameter of the current block may be calculated based on the prediction quantization parameter, the residual quantization parameter, and the quantization parameter offset.

For example, the quantization parameter offset (hereinafter, ‘prediction skipping quantization parameter offset’) depending on whether prediction is skipped may be provided as high level information. The prediction skipping quantization parameter offset may be signaled at one or more levels among the video level, the picture level, and the slice level. If the value of the prediction skipping flag is 1, the video encoding device may encode the prediction skipping quantization parameter offset and then may transmit the same to the video decoding device. Meanwhile, if the value of the prediction skipping flag is 0, the video encoding device may set the prediction skipping quantization parameter offset to 0 and may not signal the prediction skipping quantization parameter offset to the video decoding device. If the prediction skipping quantization parameter offset is not signaled, the video decoding device may infer the prediction skipping quantization parameter offset as 0. By acquiring different quantization parameter offsets according to the value of the prediction skipping flag, the video decoding device may calculate different quantization parameters depending on whether prediction is skipped.

The rearrangement unit 150 may rearrange the quantized transform coefficients within the input quantized transform block in one dimension and then may transmit the quantized transform coefficients to the entropy encoder 155 in the rearranged order.

The entropy encoder 155 may apply entropy encoding to the received quantized transform coefficients to generate a bitstream.

The inverse quantizer 160 may inversely quantize the received quantized transform block to reconstruct the transform block. The inverse quantizer 160 may check the prediction skipping information and perform inverse quantization based on the prediction skipping information. For example, the inverse quantizer 160 may use different quantization parameters depending on whether the prediction is skipped. The inversely quantized transform block may be transmitted to the inverse transformer 165.

The inverse transformer 165 may inversely transform the input inversely quantized transform block to generate a reconstructed transform block. If the prediction skipping flag is 0, the inverse transformer 165 may generate a reconstructed residual block.

Thereafter, if the prediction skipping flag is 1, the video encoding device may directly transfer the reconstructed transform block to the loop filter unit 180 and the predictor 120 without performing prediction. Meanwhile, if the prediction skipping flag is 0, the adder 170 may add the prediction block and the reconstructed residual block received from the predictor 120 to reconstruct the current block, and the reconstructed current block may be transferred to the loop filter unit 180 and the predictor 120. The reconstructed transform block or reconstructed current block transferred to the predictor 120 may be used as reference samples for intra prediction.

The loop filter unit 180 may perform one or more filtering processes on the reconstructed picture in which the input reconstructed blocks are combined to correct the reconstructed picture. The corrected picture may be transferred to and stored in the memory 190.

The memory 190 may store the received reconstructed picture. The reconstructed picture may be transmitted to the predictor 120 to generate a prediction block in a next frame.

The predictor 120 may generate a prediction block of the current block using the received reconstructed block and reconstructed picture. As described above, when the prediction skipping flag is 0, the video encoding device may generate a residual block by subtracting the generated prediction block from the current block. In addition, the video encoding device may generate a reconstructed current block by adding the reconstructed residual block and the prediction block.

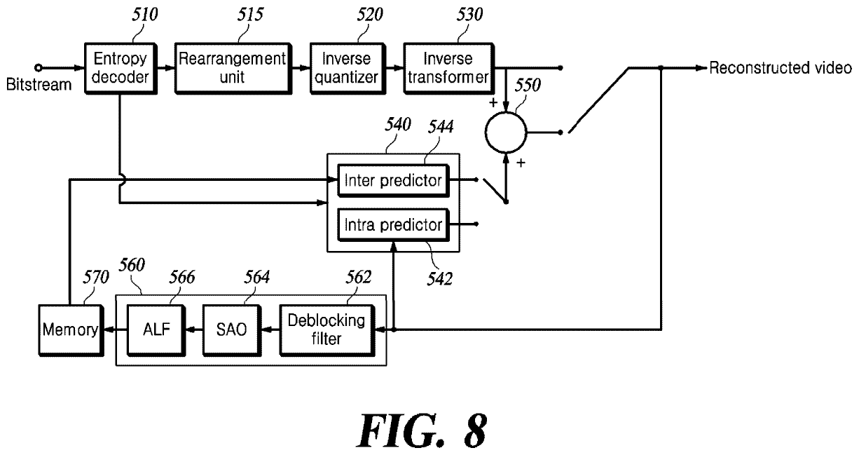

FIG. 8 is a block diagram illustrating a video decoding device using prediction skipping according to an embodiment of the present disclosure.

The video decoding device illustrated in FIG. 8 additionally includes a portion that performs prediction skipping in addition to the components illustrated in FIG. 5. Hereinafter, operations different from the example of FIG. 5 are described.

The entropy decoder 510 may decode the input bitstream to generate, for example, high level information including a prediction skipping flag. If the prediction skipping flag is not signaled, the video decoding device may infer the prediction skipping flag as 0. In addition, the entropy decoder 510 may generate reconstructed transform coefficients. The reconstructed transform coefficients may be transferred to the rearrangement unit 515.

The rearrangement unit 515 may rearrange the input reconstructed transform coefficients in the form of blocks to generate a quantized transform block. The quantized transform block may be transferred to the inverse quantizer 520.

The inverse quantizer 520 may inversely quantize the input quantized transform block to reconstruct the transform block. The inverse quantizer 520 may check the prediction skipping information and perform inverse quantization based on the prediction skipping information. For example, the inverse quantizer 520 may use different quantization parameters depending on a value of the prediction skipping flag. The inversely quantized transform block may be transferred to the inverse transformer 530.

The inverse transformer 530 may check the prediction skipping information transferred from the high level. When the prediction skipping flag is 1, the inverse transformer 530 may inversely transform the inputted inversely quantized transform block to generate a reconstructed block, and the inversely transformed reconstructed block may be transferred to the loop filter unit 560 and the predictor 540. Meanwhile, when the prediction skipping flag is 0, the inverse transformer 530 inversely transforms the inversely quantized transform block to generate a residual block. The adder 550 may add the prediction block transmitted from the predictor 540 and the residual block to generate a reconstructed block of the current block, and the reconstructed block may be transmitted to the loop filter unit 560 and the predictor 540. The inversely transformed reconstructed block or the added reconstructed block transmitted to the predictor 540 may be used as reference samples for intra prediction.

The loop filter unit 560 may correct the reconstructed picture by performing one or more filtering processes on the reconstructed picture in which the input reconstructed blocks are combined. The corrected picture may be transmitted to and stored in the memory 570.

The memory 570 may store the transmitted reconstructed picture. The reconstructed picture may be transmitted to the predictor 540 to generate a prediction block in the next frame.

The predictor 540 may generate the prediction block of the current block using the transmitted reconstructed block and reconstructed picture. As described above, when the prediction skipping flag is 0, the video decoding device may generate a reconstructed block by adding the generated prediction block and the residual block.

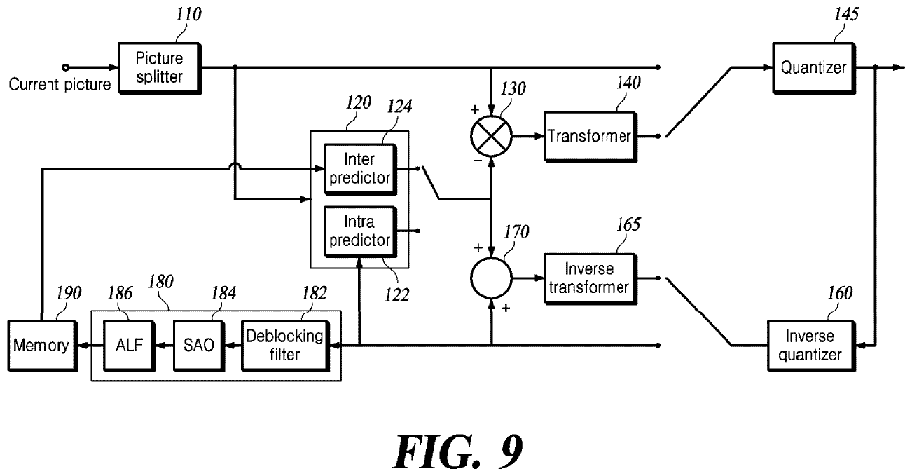

FIG. 9 is a block diagram illustrating a video encoding device using prediction-transform skipping according to an embodiment of the present disclosure.

The video encoding device illustrated in FIG. 9 further includes a portion that performs prediction-transform skipping in addition to the components illustrated in FIG. 1. Hereinafter, operations different from the example of FIG. 1 are described. In addition, operations of components not included in FIG. 9 are described based on FIG. 1.

The picture splitter 110 receives a current picture and splits the picture into a plurality of layers, such as slices/tiles, coding tree units, and coding units. Here, the coding unit represents a current block, which is a unit for coding. Thereafter, based on the prediction-transform skipping information, the current block may be directly transferred to the quantizer 145, or the residual block generated by subtracting the prediction block transferred from the predictor 120 from the current block may be transferred to the transformer 140. Hereinafter, the prediction-transform skipping information may be a prediction-transform skipping flag, which is a 1-bit flag.

For example, if the prediction-transform skipping flag is 1, the video encoding device may directly transfer the input block to the quantizer 145 without performing prediction and transform. Meanwhile, if the prediction-transform skipping flag is 0, the subtractor 130 may subtract the prediction block transferred from the predictor 120 from the current block to generate a residual block, and the residual block may be transferred to the transformer 140.

The prediction-transform skipping flag may be high level information and may be signaled at one or more levels among a video level, a picture level, and a slice level. In other words, the prediction-transform skipping flag may be encoded by the entropy encoder 155 and then may be transmitted to the video decoding device. In addition, depending on the prediction-transform skipping information of a high level than each level, the video encoding device may determine whether to encode the prediction-transform skipping flag at the corresponding level. For example, the prediction-transform skipping information of a high level than the current level may be checked, and if a value of the prediction-transform skipping flag of the high level is 0, the video encoding device may set the prediction-transform skipping flag of the current level to 0 and may not signal the prediction-transform skipping flag to the video decoding device.

The transformer 140 may transform the received residual block to generate a transform block. The generated transform block may be transmitted to the quantizer 145.

The quantizer 145 may quantize the input transform block to generate a quantized transform block. The quantizer 145 may check the prediction-transform skipping information and perform quantization based on the prediction-transform skipping information. For example, the quantizer 145 may use different quantization parameters depending on whether the prediction-transform is skipped. The generated quantized transform block may be transmitted to the rearrangement unit 150 and the inverse quantizer 160.

As described above, in the present implementation example, in order to use different quantization parameters depending on whether prediction-transform is skipped, a quantization parameter offset may be additionally utilized. In the present implementation example, the quantization parameter of the current block may be calculated based on a prediction quantization parameter, a residual quantization parameter, and a quantization parameter offset.

For example, the quantization parameter offset (hereinafter, ‘prediction-transform skipping quantization parameter offset’) depending on whether prediction-transform is skipped may be provided as high level information. The prediction-transform skipping quantization parameter offset may be signaled at one or more levels among the video level, the picture level, and the slice level. If the value of the prediction-transform skipping flag is 1, the video encoding device may encode the prediction-transform skipping quantization parameter offset and then may transmit the same to the video decoding device. Meanwhile, if the value of the prediction-transform skipping flag is 0, the video encoding device may set the prediction-transform skipping quantization parameter offset to 0 and may not signal the prediction-transform skipping quantization parameter offset to the video decoding device. If the prediction-transform skipping quantization parameter offset is not signaled, the video decoding device may infer the prediction-transform skipping quantization parameter offset as 0. By acquiring different quantization parameter offsets according to the value of the prediction-transform skipping flag, the video decoding device may calculate different quantization parameters depending on whether prediction-transform is skipped.

The rearrangement unit 150 may rearrange the quantized transform coefficients within the input quantized transform block in one dimension and then may transmit the quantized transform coefficients to the entropy encoder 155 in the rearranged order.

The entropy encoder 155 may apply entropy encoding to the received quantized transform coefficients to generate a bitstream.

The inverse quantizer 160 may inversely quantize the received quantized transform block to reconstruct the transform block. The inverse quantizer 160 may check the prediction-transform skipping information and perform inverse quantization based on the prediction-transform skipping information. For example, the inverse quantizer 160 may use different quantization parameters depending on whether the prediction-transform is skipped.

Thereafter, when the prediction-transform skipping flag is 1, the video encoding device may directly transfer the inversely quantized transform block to the loop filter unit 180 and the predictor 120 without performing prediction and transform. Meanwhile, when the prediction-transform skipping flag is 0, the video encoding device may transfer the inversely quantized transform block to the inverse transformer 165. The inversely quantized transform block transferred to the predictor 120 may be used as reference samples for intra prediction.

The inverse transformer 165 may inversely transform the received inversely quantized transform block to generate a reconstructed residual block. The adder 170 may add the prediction block and the reconstructed residual block received from the predictor 120 to reconstruct the current block, and the reconstructed current block may be transferred to the loop filter unit 180 and the predictor 120. The reconstructed current block transferred to the predictor 120 may be used as reference samples for intra prediction.

The loop filter unit 180 may perform one or more filtering processes on the reconstructed picture in which the inputted reconstructed blocks are combined to correct the reconstructed picture. The corrected picture may be transferred to and stored in the memory 190.

The memory 190 may store the received reconstructed picture. The reconstructed picture may be transmitted to the predictor 120 to generate a prediction block in a next frame.

The predictor 120 may generate a prediction block of the current block using the received reconstructed block and reconstructed picture. As described above, when the prediction-transform skipping flag is 0, the video encoding device may generate a residual block by subtracting the generated prediction block from the current block. In addition, the video encoding device may generate a reconstructed current block by adding the reconstructed residual block and the prediction block.

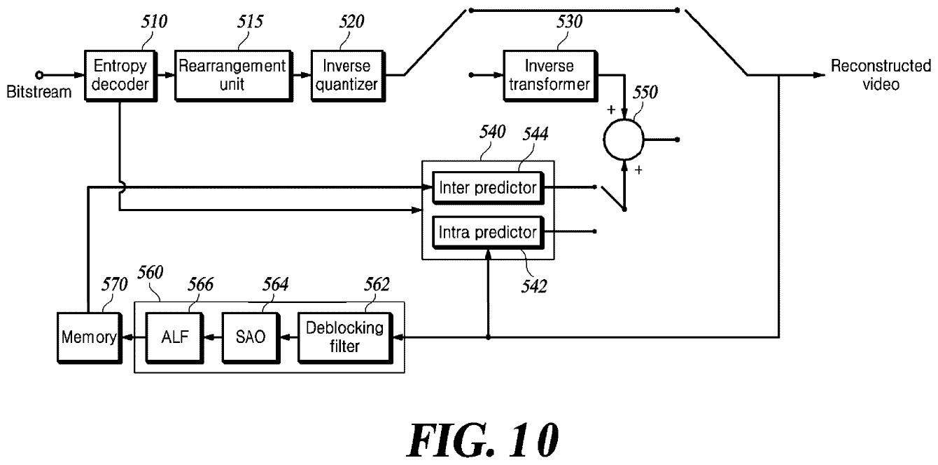

FIG. 10 is a block diagram illustrating a video decoding device using prediction-transform skipping according to an embodiment of the present disclosure.

The video decoding device illustrated in FIG. 10 further includes a portion that performs prediction-transform skipping in addition to the components illustrated in FIG. 5. Hereinafter, operations different from the example of FIG. 5 are described.

The entropy decoder 510 may decode the input bitstream to generate, for example, high level information including a prediction-transform skipping flag. If the prediction skipping flag is not signaled, the video decoding device may infer the prediction skipping flag as 0. In addition, the entropy decoder 510 may generate reconstructed transform coefficients. The reconstructed transform coefficients may be transferred to the rearrangement unit 515.

The rearrangement unit 515 may rearrange the input reconstructed transform coefficients in the form of blocks to generate a quantized transform block. The quantized transform block may be transferred to the inverse quantizer 520.

The inverse quantizer 520 may inversely quantize the input quantized transform block to reconstruct the transform block. The inverse quantizer 520 may check the prediction-transform skipping information and perform inverse quantization based on the prediction-transform skipping information. For example, the inverse quantizer 520 may use different quantization parameters depending on a value of the prediction-transform skipping flag.

Thereafter, if the prediction-transform skipping flag is 1, the video decoding device may directly transfer the inversely quantized transform block to the loop filter unit 560 and the predictor 540 without performing prediction and transform. Meanwhile, if the prediction-transform skipping flag is 0, the video decoding device may transfer the inversely quantized transform block to the inverse transformer 530. The inversely quantized transform block transferred to the predictor 540 may be used as reference samples for intra prediction.

The inverse transformer 530 may inversely transform the received inversely quantized transform block to generate a residual block. The adder 550 adds the prediction block transmitted from the predictor 540 and the residual block to generate a reconstructed block of the current block, and the reconstructed block may be transmitted to the loop filter unit 560 and the predictor 540. The reconstructed block transmitted to the predictor 540 may be used as reference samples for intra prediction.

The loop filter unit 560 may correct the reconstructed picture by performing one or more filtering processes on the reconstructed picture in which the input reconstructed blocks are combined. The corrected picture may be transmitted to and stored in the memory 570.

The memory 570 may store the transmitted reconstructed picture. The reconstructed picture may be transmitted to the predictor 540 to generate a prediction block in the next frame.

The predictor 540 may generate the prediction block of the current block using the transmitted reconstructed block and reconstructed picture. As described above, when the prediction-transform skipping flag is 0, the video decoding device may generate a reconstructed block by adding the generated prediction block and the residual block.

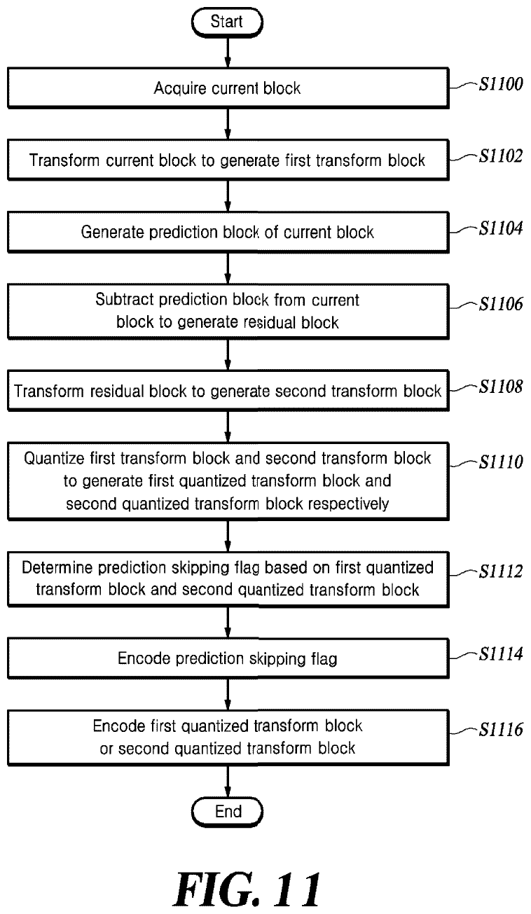

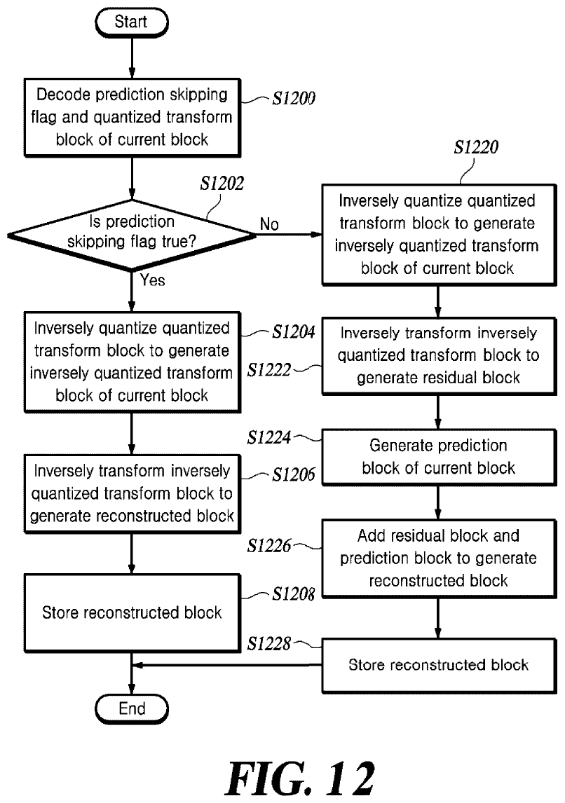

Hereinafter, a method of encoding and decoding a current block using prediction skipping will be described using the illustrations of FIGS. 11 and 12.

FIG. 11 is a flowchart illustrating a method of encoding a current block performed by a video encoding device according to an embodiment of the present disclosure.

The video encoding device acquires a current block (S1100). The current block may be split from a current picture.

The video encoding device transforms the current block to generate a first transform block (S1102). The video encoding device generates the first transform block, while skipping the prediction process.

The video encoding device generates a prediction block of the current block (S1104).

The video encoding device subtracts the prediction block from the current block to generate a residual block (S1106).

The video encoding device transforms the residual block to generate a second transform block (S1108).

The video encoding device quantizes each of the first transform block and the second transform block to generate a first quantized transform block and a second quantized transform block (S1110). In order to generate the first quantized transform block and the second quantized transform block, the video encoding device may use different quantization parameters depending on whether prediction skipping is applied.

The video encoding device determines a prediction skipping flag based on the first quantized transform block and the second quantized transform block (S1112), Here, the prediction skipping flag indicates skipping of prediction for the current block. By evaluating the first quantized transform block and the second quantized transform block in terms of rate distortion optimization, the video encoding device may determine a prediction skipping flag of the current block. For example, if the first quantized transform block is more optimal, the prediction skipping flag may be set to true, and if the second quantized transform block is more optimal, the prediction skipping flag may be set to false.

The video encoding device encodes the prediction skipping flag (S1114).

Meanwhile, the video encoding device may check the prediction skipping flag of the level. Here, the high level may be a video level, a picture level, or a slice level. The video encoding device may set the prediction skipping flag of the high level in advance in terms of rate distortion optimization. If the prediction skipping flag of the high level is false, the video encoding device may skip the operation of determining the prediction skipping flag for the current block and the operation of encoding.

The video encoding device encodes the first quantized transform block or the second quantized transform block based on the prediction skipping flag (S1116).

FIG. 12 is a flowchart illustrating a method of decoding a current block performed by a video decoding device according to an embodiment of the present disclosure.

The video decoding device decodes the prediction skipping flag of the current block and the quantized transform block of the current block from a bitstream (S1200). Here, the prediction skipping flag indicates skipping of prediction for the current block.

Meanwhile, the video decoding device may check the prediction skipping flag of the high level. Here, the high level may be a video level, a picture level, or a slice level. The video decoding device may decode the high level prediction skipping flag from the bitstream before decoding the prediction skipping flag of the current block. If the high level prediction skipping flag is false, the video decoding device may infer the prediction skipping flag for the current block as false.

The video decoding device checks the prediction skipping flag (S1202).

First, if the prediction skipping flag is true (Yes in S1202), the video decoding device performs the following operations.

The video decoding device inversely quantizes the quantized transform block to generate an inversely quantized transform block of the current block (S1204).

In order to inversely quantize the quantized transform block, the video decoding device may use different quantization parameters based on the prediction skipping flag.

The video decoding device inversely transforms the inversely quantized transform block to generate a reconstructed block (S1206).

The video decoding device stores the reconstructed block (S1208). The stored reconstructed block may be used later to filter the current picture and predict the next block.

Meanwhile, if the prediction skipping flag is false (No in S1202), the video decoding device may perform the following operations.

The video decoding device inversely quantizes the quantized transform block to generate an inversely quantized transform block of the current block (S1220).

In order to inversely quantize the quantized transform block, the video decoding device may use different quantization parameters based on the prediction skipping flag.

The video decoding device inversely transforms the inversely quantized transform block to generate a residual block (S1222).

The video decoding device generates a prediction block of the current block (S1224).

The video decoding device adds the residual block and the prediction block to generate a reconstructed block (S1226).

The video decoding device stores the reconstructed block (S1228). The stored reconstructed block may be used later to filter the current picture and predict the next block.

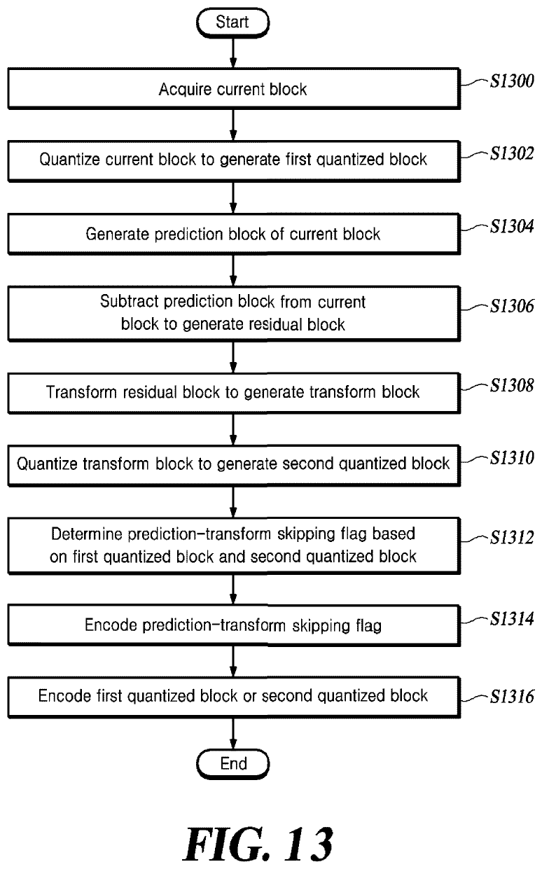

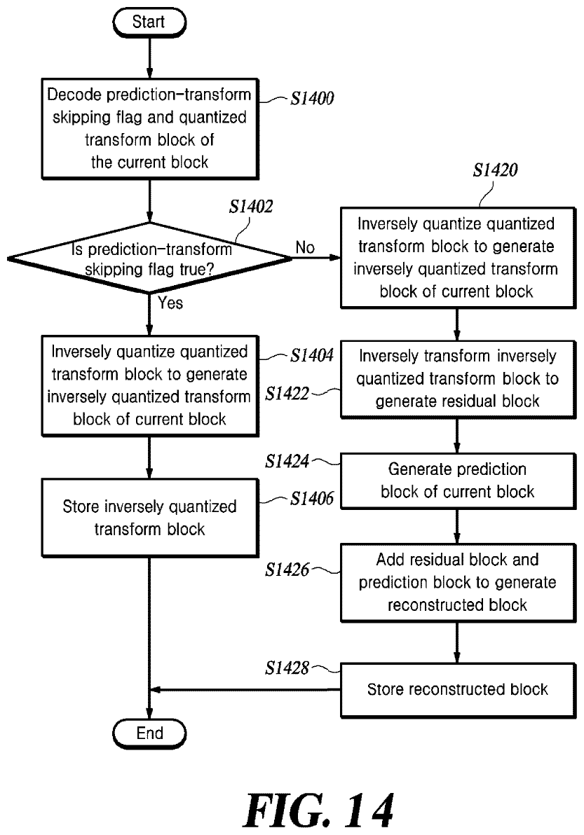

Hereinafter, a method of encoding and decoding a current block using prediction-transform skipping is described using the illustrations of FIGS. 13 and 14.

FIG. 13 is a flowchart illustrating a method of encoding a current block performed by a video encoding device according to another embodiment of the present disclosure.

The video encoding device acquires a current block (S1300). The current block may be split from a current picture.

The video encoding device quantizes the current block to generate a first quantization block (S1302). The video encoding device generates a first transform block, while skipping the prediction and transform processes.

The video encoding device generates a prediction block of the current block (S1304).

The video encoding device subtracts the prediction block from the current block to generate a residual block (S1306).

The video encoding device transforms the residual block to generate a transform block (S1308).

The video encoding device quantizes the transform block to generate a second quantization block (S1310).

The video encoding device determines a prediction-transform skipping flag based on the first quantization block and the second quantization block (S1312). Here, the prediction-transform skipping flag indicates skipping of prediction and transform for the current block. By evaluating the first quantization block and the second quantization block in terms of rate distortion optimization, the video encoding device may determine the prediction-transform skipping flag of the current block. For example, if the first quantization block is more optimal, the prediction-transform skipping flag may be set to true, and if the second quantization block is more optimal, the prediction-transform skipping flag may be set to false.

The video encoding device encodes the prediction-transform skipping flag (S1314).

Meanwhile, the video encoding device may check the prediction-transform skipping flag of the high level. Here, the high level may be a video level, a picture level, or a slice level. The video encoding device may set the prediction-transform skipping flag of the high level in advance in terms of rate distortion optimization. If the prediction-transform skipping flag of the high level is false, the video encoding device may skip the operation of determining the prediction-transform skipping flag for the current block and the operation of encoding.

Meanwhile, the video encoding device may use different quantization parameters to generate the first quantization block and the second quantization block.

The video encoding device encodes the first quantization block or the second quantization block based on the prediction-transform skipping flag (S1316).

FIG. 14 is a flowchart illustrating a method of decoding a current block performed by a video decoding device according to another embodiment of the present disclosure.

The video decoding device decodes the prediction-transform skipping flag and the quantized transform block of the current block from the bitstream (S1400). Here, the prediction-transform skipping flag indicates skipping of prediction and transform for the current block.

Meanwhile, the video decoding device may check the prediction-transform skipping flag of the high level. Here, the high level may be a video level, a picture level, or a slice level. The video decoding device may decode the prediction-transform skipping flag of the high level from the bitstream before decoding the prediction-transform skipping flag of the current block. If the prediction-transform skipping flag of the high level is false, the video decoding device may infer the prediction-transform skipping flag for the current block as false.

The video decoding device checks the prediction-transform skipping flag (S1402).

First, if the prediction-transform skipping flag is true (Yes in S1402), the video decoding device performs the following operations.

The video decoding device inversely quantizes the quantized transform block to generate an inversely quantized transform block of the current block (S1404).

In order to inversely quantize the quantized transform block, the video decoding device may use different quantization parameters based on the prediction-transform skipping flag.

The video decoding device stores the inversely quantized transform block (S1406). The stored inversely quantized transform block may be used later to filter the current picture and predict the next block.

Meanwhile, if the prediction-transform skipping flag is false (No in S1402), the video decoding device may perform the following operations.

The video decoding device inversely quantizes the quantized transform block to generate an inversely quantized transform block of the current block (S1420).

In order to inversely quantize the quantized transform block, the video decoding device may use different quantization parameters based on the prediction-transform skipping flag.

The video decoding device inversely transforms the inversely quantized transform block to generate a residual block (S1422).

The video decoding device generates a prediction block of the current block (S1424).

The video decoding device adds the residual block and the prediction block to generate a reconstructed block (S1426).

The video decoding device stores the reconstructed block (S1428). The stored reconstructed block may be used later to filter the current picture and predict the next block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “. . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

120: predictor
140: transformer
145: quantizer
160: inverse quantizer
165: inverse transformer
180: loop filter unit
520: inverse quantizer
530: inverse transformer
540: predictor
560: loop filter unit

### CROSS-REFERENCE TO RELATED APPLICATIONS

This application claims priority to and the benefit of Korean Patent Application No. 10-2022-0059428 filed on May 16, 2022, and Korean Patent Application No. 10-2023-0057062, filed on May 2, 2023, the entire contents of each of which are incorporated herein by reference.

What is claimed is:

1. A method of decoding a current block, performed by a video decoding device, the method comprising:
decoding a prediction skipping flag and a quantized transform block of the current block from a bitstream, wherein the prediction skipping flag indicates skipping of prediction for the current block;
generating an inversely quantized transform block of the current block by inversely quantizing the quantized transform block; and
checking the prediction skipping flag,
wherein, when the prediction skipping flag is true, the method further comprises:
generating a reconstructed block by inversely transforming the inversely quantized transform block; and
storing the reconstructed block to filter a current picture and predict a next block.

2. The method of claim 1, wherein, when the prediction skipping flag is false, the method further comprises:
inversely transforming the inversely quantized transform block to generate a residual block;
generating a prediction block of the current block;
adding the residual block and the prediction block to generate the reconstructed block; and
storing the reconstructed block.

3. The method of claim 1, further comprising:
checking a prediction skipping flag of a high level that has been pre-decoded,
wherein, when the prediction skipping flag of the high level is false, the method further comprises:
inferring the prediction skipping flag as false for the current block.

4. The method of claim 1, wherein generating the inversely quantized transform block includes:
using different quantization parameters based on the prediction skipping flag.

5. A method of decoding a current block, performed by a video encoding device, the method comprising:
acquiring the current block;
generating a first transform block by transforming the current block;
generating a prediction block of the current block;
generating a residual block by subtracting the prediction block from the current block; and
generating a second transform block by transforming the residual block.

6. The method of claim 5, further comprising:
generating a first quantized transform block and a second quantized transform block by quantizing the first transform block and the second transform block, respectively,
determining a prediction skipping flag indicating skipping of prediction for the current block based on the first quantized transform block and the second quantized transform block; and
encoding the prediction skipping flag.

7. The method of claim 6, further comprising:
checking a prediction skipping flag of a high level,
wherein, when the prediction skipping flag of the high level is false, the method further comprises:
skipping encoding the prediction skipping flag for the current block.

8. The method of claim 6, further comprising:
encoding the first quantized transform block or the second quantized transform block based on the prediction skipping flag.

9. The method of claim 5, wherein generating a first quantized transform block and a second quantized transform block includes:
quantizing the first transform block and the second transform block based on different quantization parameters.

10. A computer-readable recording medium storing a bitstream generated by a video encoding method, the video encoding method comprising:
acquiring a current block;
generating a first transform block by transforming the current block;
generating a prediction block of the current block;
generating a residual block subtracting the prediction block from the current block; and
generating a second transform block by transforming the residual block.
